(19) United States
(12) Patent Application Publication
(10) Pub. No.: US 2025/0059793 A1
(43) Pub. Date: Feb. 20, 2025

(54) A ROOFTOP TENT

(71) Applicant: Rebecca GOODWIN, Johannesburg (ZA)

(72) Inventors: Robin Stuart ROBERTSON, Johannesburg (ZA); Sebastian RIVETT-CARNAC, Johannesburg (ZA); Jeremy CORBETT, Johannesburg (ZA)

(21) Appl. No.: 18/721,408

(22) PCT Filed: Dec. 19, 2022
(86) PCT No.: PCT/ZA2022/050070

§ 371 Date: Jun. 18, 2024

(30) Foreign Application Priority Data
Dec. 24, 2021 (ZA) 2021/10951

(51) Int. Cl. E04H 15/06; E04H 15/48; E06C 1/12

(52) U.S. Cl. CPC E04H 15/06; E04H 15/48; E06C 1/12

(57) ABSTRACT

The invention provides a rooftop tent for a vehicle which includes a base detachably fixed to a roof of the vehicle, which includes a first load bearing panel and a perimeter frame which engages a perimeter of the first panel, a base extension rotatably connected to the base, a cover rotatably connected to the base to open and close on an upper surface of the base, which includes a second load bearing panel and a sidewall which extends between an upper edge and a lower edge, which engages the second flat at the upper edge, a tent unit connected to the base plate and the cover and which moves from a folded configuration when the cover is closed and the base extension is in a retracted position, to an open configuration when the cover is open and the base extension is in an extended position.

### PRIOR RELATED APPLICATIONS

The present application is a National Entry of PCT Application No. PCT/ZA2022/050070, filed on Dec. 19, 2022, which claims priority under the Paris Convention to South African Application No. ZA 2021/10951, filed on Dec. 24, 2021. The entire contents of such prior applications are incorporated by reference herein.

### FIELD OF THE INVENTION

This invention relates to a rooftop tent and more particularly to a fold-out rooftop tent encased within a hard-shell housing.

### BACKGROUND OF THE INVENTION

A rooftop tent refers to a tent assembly which is engaged to a roof of a vehicle and which can be opened, from a closed configuration, to present a ready-made tented enclosure. The benefit of such a tent is that it is easily and quickly installed and it provides a shelter that is safety elevated off the ground, a particular benefit when camping in wild areas where animals are ever present.

A typical hard-shell roof top tent includes a fabric tent unit which is contained within an enclosure, defined between a rigid cover and a base, and attached to both the cover and the base. The cover is hinged to the base, allowing the cover to rotate between a closed position and an open position. When the cover is rotated to the open position, the tent unit is moved in unison, stretching out within a receiving space between the cover and the base, into an assembled configuration.

Motivated by the need to minimise the weight of a rooftop tent, a hard-shell cover is typically made of a lightweight, low density, material such as, for example, a rigid plastics material, fibreglass or aluminium. Driven by this imperative, the hard-shell is not generally load supportive, preventing a top surface area of the cover from being used as a storage platform. With most of the limited roof space on the vehicle now taken up by the rooftop tent, other camping equipment and supplies must be stored elsewhere in the vehicle where space would be in short supply.

Moreover, when such a tent is put in use, with a person sleeping within the tent overnight, warm humid air builds up within the tent. In the morning, when the rooftop tent is closed, much of this warm humid air is trapped within the enclosure, condensing on the inner surfaces of the cover. Overtime, this can lead to the growth of mould and mildew within the enclosure. In cold climes, the construction of regular tents leads to increased cold bridging leading to increased temperature loss through the shell, increasing condensation within the tent.

Another problem with hard-shell rooftop tent design, such as described above, lies in their bulk. Factory assembled hard-shell rooftop tents are generally made of prefabricated hard shells and bases that are of significant volume which increases the cost of transporting the tent to wholesale and retail customers.

The present invention at least partially addresses the problems.

### SUMMARY OF INVENTION

The invention provides a rooftop tent enclosure which includes;
a base detachably fixed to a roof of the vehicle, which includes a first load bearing base panel and a perimeter frame which engages a perimeter of the first base panel;
a base extension rotatably connected to the base;
a cover rotatably connected to the base to open and close on an upper surface of the base, which includes a second load bearing flat panel and a sidewall which extends between an upper edge and a lower edge, which engages the second flat panel at the upper edge.

The base extension may include a third load bearing panel and a perimeter mount which engages a perimeter of the third flat panel.

The first panel, the second panel and the third panel include an upper rigid plate and a lower rigid plate and a core sandwiched between the upper and the lower plates.

Alternatively, the first and third panels include an upper rigid plate and a lower rigid plate and a core sandwiched between the upper and the lower plates and the second panel is composed of a single rigid plate.

The rigid plates may be made of a suitable lightweight metal material such as, for example, aluminium, fibreglass or carbon fibre.

The core may be a structural foam, made of an expanded polypropylene foam, a polyurethane foam or a polyvinylchloride foam. Alternatively, the core may have a honeycomb configuration, made of a thermoplastic material such as, for example, polypropylene.

The upper edge of the sidewall may be folded to provide a shelf upon which the second flat panel engages in load bearing support.

The sidewall may be of modular configuration, comprising four side-panels and four corner panels, each corner panel connecting a respective pair of side panels.

The side-panels and the corner panels may be convexly curved from a lower edge of a first perimetrical extent, to an upper edge of a second perimetrical extent, wherein the first perimetrical extent is larger than the second perimetrical extent.

The perimeter frame may be of modular configuration, comprising four side channels, each corner element connecting a respective pair of side channels.

The perimeter mount may be of modular configuration, comprising four side rails and at least two corner pieces, each corner piece connecting a respective pair of side rails.

The invention extends to providing a rooftop tent for a vehicle which includes:
a base detachably fixed to a roof of the vehicle, which includes a first load bearing panel and a perimeter frame which engages a perimeter of the first flat panel;
a base extension rotatably connected to the base;
a cover rotatably connected to the base to open and close on an upper surface of the base, which includes a second load bearing panel and a sidewall which extends between an upper edge and a lower edge, which engages the second panel at the upper edge;
a tent unit connected to the base plate and the cover.

The base extension may include a third load bearing panel and a perimeter mount which engages a perimeter of the third flat panel.

The first panel, the second panel and the third panel include an upper rigid plate and a lower rigid plate and a core sandwiched between the upper and the lower plates.

Alternatively, the first and third panels include an upper rigid plate and a lower rigid plate and a core sandwiched between the upper and the lower plates and the second panel is composed of a single rigid plate.

The rigid plates may be made of a suitable lightweight metal material such as, for example, aluminium, fibreglass or carbon fibre.

The core may be a structural foam, made of an expanded polypropylene foam, a polyurethane foam or a polyvinylchloride foam. Alternatively, the core may have a honeycomb configuration, made of a thermoplastic material such as, for example, polypropylene.

The side-panels and the corner panels may be convexly curved from a lower edge of a first perimetrical extent, to an upper edge of a second perimetrical extent, wherein the first perimetrical extent is larger than the second perimetrical extent.

The base extension may move from a first position in which the base extension overlaps the base, to a second position in which the base extension extends from the base to form a single flat-bed deck to which mattresses are already affixed.

The tent unit may move from a folded configuration when the cover is closed and the base extension is in the first position, to an open configuration when the cover is open and the base extension is in the second position.

### BRIEF DESCRIPTION OF THE DRAWINGS

The invention is further described by way of examples with reference to the accompanying drawings in which:

FIG. 1 is a view in perspective of a vehicle with a pair of open rooftop tents, one with canvas fitted (front) and one without, in accordance with the invention engaged to a roof of the vehicle;

FIG. 2 is a view in perspective of a rooftop tent of a first embodiment in an open configuration, without the canvas fitted;

FIG. 3 is a view from a side of the rooftop tent of FIG. 2;

FIG. 4 is the rooftop tent of FIG. 3 illustrating a tent unit fully extended in an open configuration, with the canvas fitted;

FIG. 5 is a view in perspective and from above of the rooftop tent enclosure of FIG. 6;

FIG. 6 is a view in cross section through a rooftop tent enclosure in a closed configuration showing the components of the rooftop tent in a folded state;

FIG. 7 is a view in cross section through a rooftop tent enclosure in a closed configuration without the contained components of the rooftop tent;

FIG. 8 is a view in cross section through a part of the enclosure designated 8 on FIG. 7;

FIG. 9 is a view in cross section through a part of the enclosure designated 9 on FIG. 7;

FIG. 10 is an exploded view in perspective of the components that comprise a base of the rooftop tent;

FIG. 11 is an exploded view in perspective of the components that comprise a cover of the rooftop tent;

FIG. 12 is an exploded view in perspective of the components that comprise a base extension of the rooftop tent;

FIG. 13 is a view in perspective of a cover of a rooftop tent in accordance with a second embodiment of the invention;

FIG. 14 is an exploded view in perspective of the components that comprise the cover of FIG. 13; and

FIG. 15 is a view in cross section through a sidewall of the cover of FIG. 13.

### DESCRIPTION OF PREFERRED EMBODIMENTS

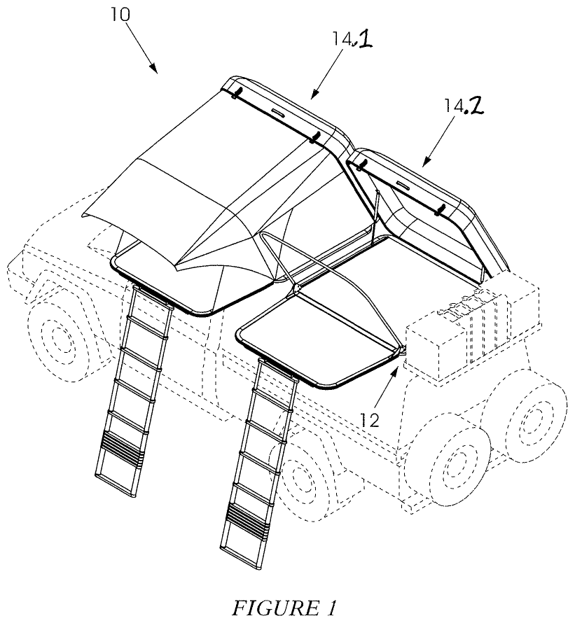

FIG. 1 illustrates a vehicle 10, more particularly an SUV. A pair of roof top tents (14.1 and 14.2) is detachably engaged to a roof 12 of this SUV. Each of these tents accords with the invention.

The roof top tent 14 comprises a base 16, a hard-shell lid or cover 18, a fold-out base extension 20, a tent unit 22 (see FIG. 3) and an articulated tent support arched frame 24.

The base 16 is detachably fixed to a preinstalled roof rack or load bars (not shown) the roof 12 of the vehicle 10. However, this is merely an example, and the invention is not limited to the way the base is fixed to the roof.

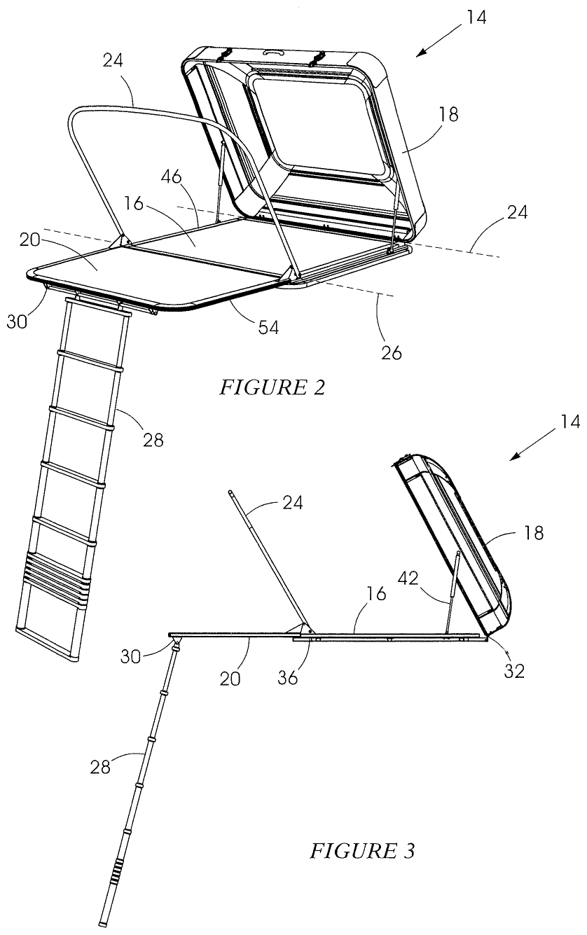

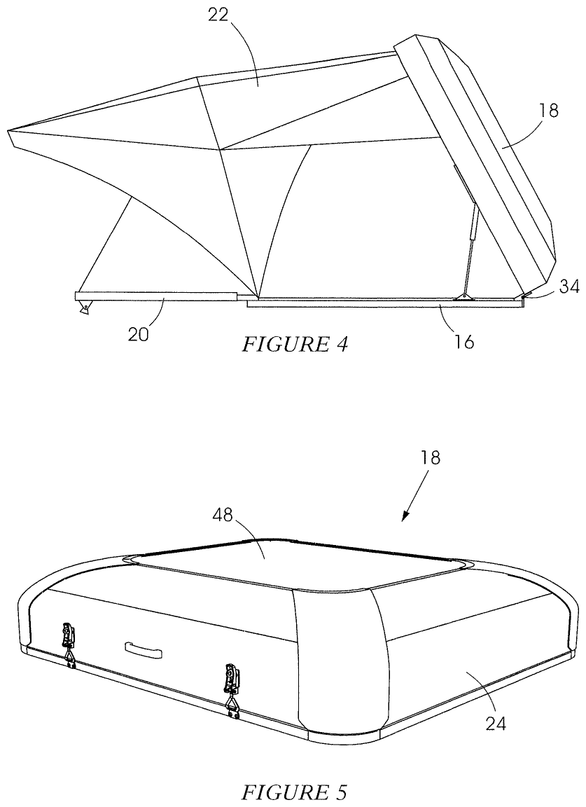

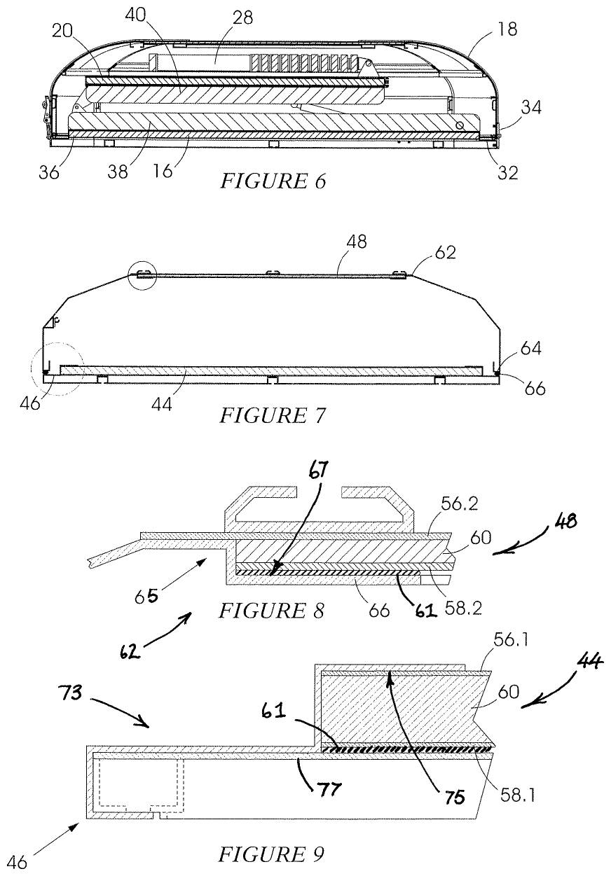

The cover 18 is pivotally connected to the base 16, allowing the cover to move about a first pivot axis 24 (illustrated as a dotted line on FIG. 2) between an open position (illustrated in FIG. 2) and a closed position (illustrated in FIG. 4). In the closed position, the cover closes upon an upper surface of the base 16.

The base extension 20 is pivotally connected to the base 16, allowing the base extension to move about a second pivot axis 26 (illustrated as a dotted line on FIG. 2) between a first “folded” position in which the base extension overlaps the base (as illustrated in FIG. 5) and a second “extended” position in which the base extension extends from the base in a co-planar array (as illustrated in FIG. 2).

The base and the base extension, in the extended position, define a tent length. As illustrated in FIG. 1, the tent length is orientated in a direction transverse to the front-rear direction of the vehicle. This is not limiting on the invention as, alternatively, the tent can be mounted in the front-rear direction to allow the tent to open over the front or rear of the vehicle.

The tent unit 22 is connected to the cover 18, the base 16 and the base extension 20 and extends over the tent support arch 24. With the cover in the closed position, and the base extension on the folded position, as illustrated in FIG. 5, the tent unit is in a folded down storage/transport state, contained within an enclosure defined within the cover, closed on the base. When required to be used, the tent unit is automatically erected by opening the cover from the closed to the open and rotating the base extension from the folded to the extended position along axis 26 by means of an offset hinge bracket 36. The tent support arch 24 also rotates about the second pivot axis 26 from a folded down state to an erect state (illustrated in FIGS. 2 and 3) to support the tent unit in its assembled configuration as illustrated in FIG. 4.

To access the assembled tent unit 22, the rooftop tent is provided with a telescopically extensible ladder 28. This ladder is pivotally attached to an outer edge 30 of the base extension 20. The ladder can be elongated in a telescopic manner, when needed to be used, or collapsed and folded to lie atop the base extension before packing away the rooftop tent when not in use.

As best illustrated in FIG. 3, the cover is fixed to a first edge 32 of the base 16 by a plurality of hinges 34. At a second edge 36, opposite the first edge, the base extension 20 is connected thereto with a pair of hinging connectors 36.

A first mattress 38 and a second mattress 40 are adhered to the base 16 and the base extension 20 respectively to present a single co-planar sleeping surface when the base extension is in the extended position relatively to the base.

The rooftop tent 14 is also provided with a pair of pressurised gas piston stays 42 which interconnect the cover 18 to the base 16 and which assist in opening the cover and allow the cover to remain in the open position, preventing its collapse to the closed position.

The base 16 comprises a first load bearing flat panel 44 and a frame 46. This rectangular panel is supported on all sides within the frame. Similarly, the cover 18 comprises a second load bearing panel 48 (which in this embodiment is flat square or rectangular), and a sidewall 50 that circumscribes the panel 48 which curves convexly away from a plane of the panel to provide a load-bearing domed cover structure which when closed on the base defines the enclosure.

The base extension 20 is similar in configuration to the base 16, having a third load bearing flat panel 52 and a perimeter mount 54 which supports the panel on all sides.

The first, second and third load bearing panels (44, 48 and 52) each are constructed with an upper rigid plate (respectively 56.1, 56.2, 56.3) and a lower rigid plate (respectively 58.1, 58.2, 58.3) and a core 60 sandwiched between the upper and the lower plates.

The upper rigid plate and the lower rigid plate are made of a suitable lightweight metal material such as, for example, aluminium or fibreglass or carbon fibre. The core is a structural foam, made of an expanded polypropylene foam, a polyurethane foam or a polyvinylchloride foam. Alternatively, the core can be a honeycomb configuration, made of a thermoplastic material such as, for example, polypropylene. The rigid plates are adhered to the core using a suitable adhesive.

By constructing each of the panels (44, 48, 52) in this manner, the rooftop tent is provided with load supporting surfaces that have compressive and torsional strength and yet remain light weight. The first and third panels support a sleeping surface and provide load bearing support to a person sleeping within the tent unit whilst the second panel provides a surface on top of which items, such as luggage or containers with a weight up to 70 kgs, can be placed secured to when travelling within the vehicle.

These panels are also provided with an insulation layer 61 sandwiched between the core 60 and either the upper or lower rigid plate (56, 58). This confers on the respective panel an important secondary function as an insulated thermal break between the inside and the outside temperatures to provide warmth at night and to keep cool during the day. The reduction in the temperature differential in the inside surface of the hard-shell panels reduces the condensation that builds up overnight from people sleeping within, creating a warm interior whilst outside surfaces of the hard-shell are cold.

The sidewall 50 of the cover 18 is made of aluminium and, importantly, provides a load spreading structure to the second load bearing panel 48. The sidewall extends in depth between an upper edge 62 which engages the panel and a lower edge 64. A rubber seal 66 extends along this lower edge forming a barrier between the cover and the base 16 (see FIG. 7).

Referring to FIG. 8, the upper edge 62 of the sidewall is folded, first downwardly and then outwardly, to provide a first stepped structure 65 which provides a shelf 67 onto which the second panel locates in engagement of the sidewall and the panel. A perimeter section of the upper plate 56.2 of the panel overlaps the shelf. Both these structural features lend support and strength to the second panel when items are placed on top of it.

The sidewall is modular in construction, made of a plurality of four side-panels, respectively designated 68.1, 68.2, 68.3 and 68.4, and four corner panels made of a rigid plastic material, respectively designated 70.1, 70.2, 70.3 and 70.4. Each side panel and corner panel are formed with the convexly curved shape of the sidewall. As illustrated in FIG. 11, in assembly of the cover 18, each corner panel fits, and is fixed (by any suitable means), between a respective pair corner panels. Once the rectangular structure of the sidewall is assembled, the second panel 58 fits within a complementarily shaped recess defined by the upper edge 62 of the sidewall and fixed in place.

The load spreading structure of the sidewall 50 results from the side-panels and the corner panels being convexly curved/shaped from the lower edge 64 of a first perimetrical extent, to an upper edge 62 of a second perimetrical extent, and with the first perimetrical extent being larger than the second perimetrical extent

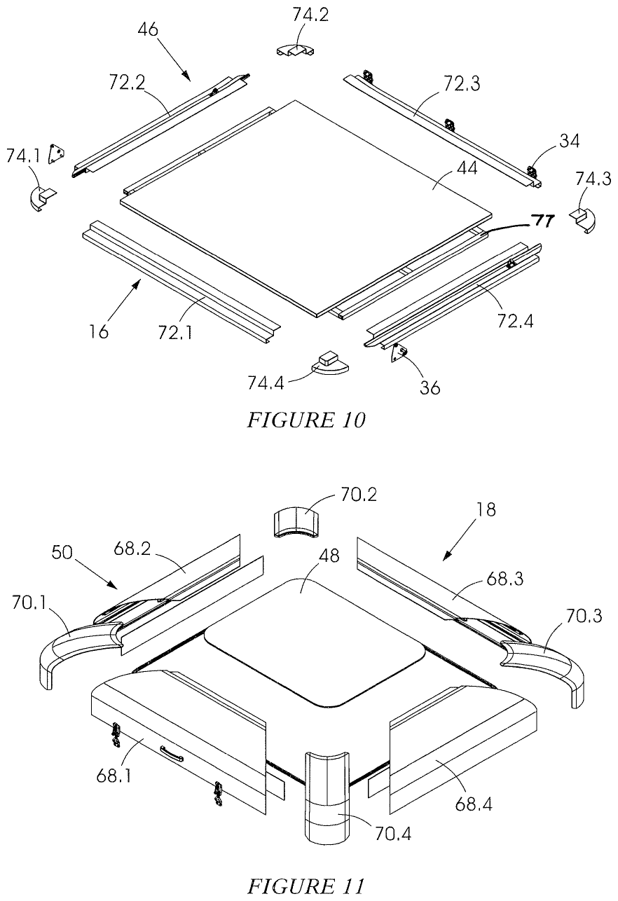

Like the sidewall, the perimeter frame 46 of the base 16 is of modular configuration, comprising four side channels, respectively designated 72.1, 72.2, 72.3 and 72.4, and four corner elements, respectively designated 74.1, 74.2, 74.3 and 74.4. In assembly of the base, each corner element fits, and is fixed, between a respective pair of side channels and each corner element and side channel fits and is fixed to a respective corner or side of the first panel 44. FIG. 10 illustrates this.

Referring to FIG. 9, the frame 46 is formed to provide a second stepped structure 73 which provides an inward extending overhang section 75 below which a perimeter part of the first panel 44 locates supported on a platform 77. An insulating layer is sandwiched between the platform and the lower rigid plate 58.1.

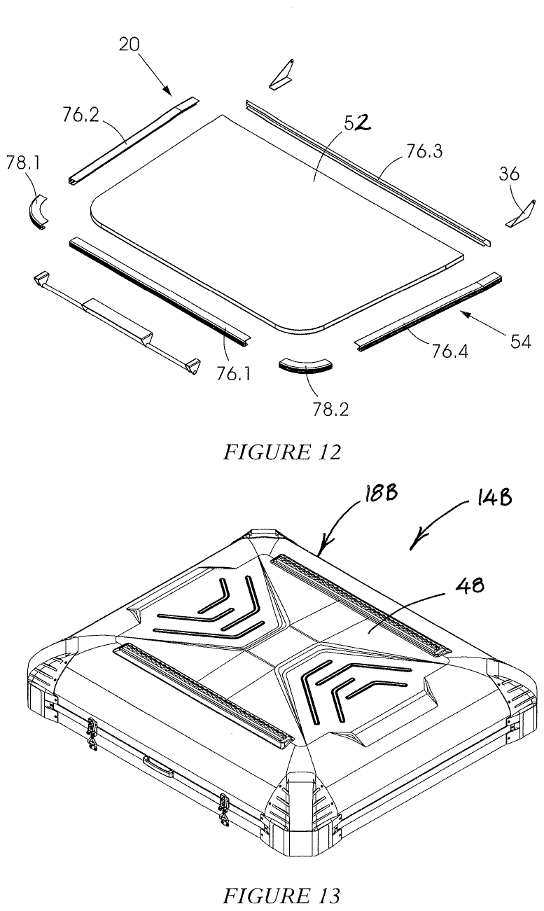

Completing the modularity of the rooftop tent 14, the perimeter mount 54 of the base extension 20 comprises four side rails (76.1, 76.2, 76.3, and 76.4) and at least two corner pieces (78.1, 78.2). Each corner piece fits and is fixed between a respective pair of side rails before being affixed to a respective corner module of the third panel 50 (see FIG. 12).

With the base 16, the cover 18 and the base extension 20 now assembled, the cover can be pivotally connected to the base, along the first pivot axis 24, with use of the hinges 34 and the base extension can be connected to the base, along the second pivot axis 26, with use of the hinging connectors 36.

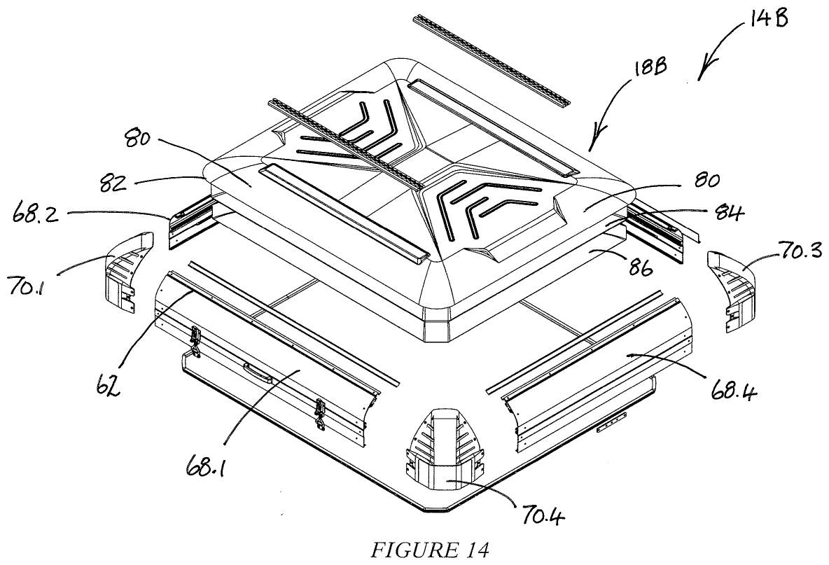

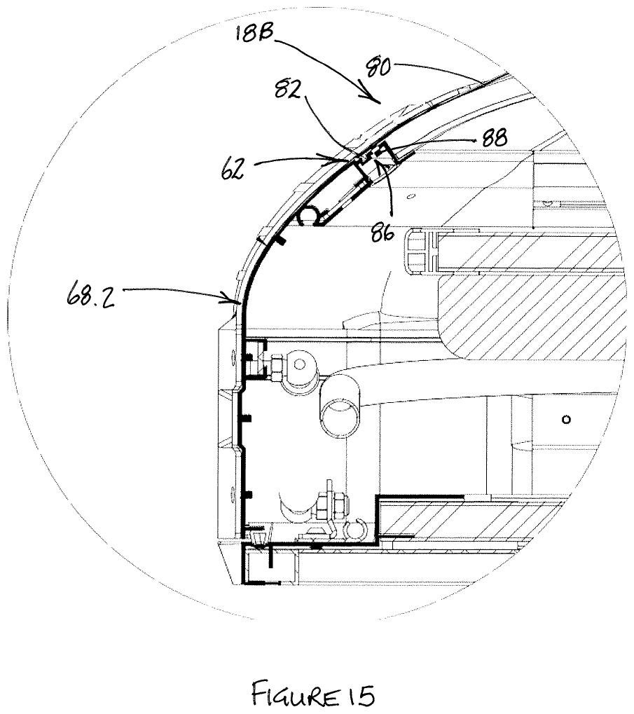

In another embodiment, as illustrated in FIGS. 13 and 14, the rooftop tent 14B differs from the earlier described embodiment in the construction of the lid 18B. In this embodiment, the lid has a second load bearing panel 48B which differs from the earlier embodiment in being larger, comprised of an outer section 80 which ends about an edge 82 and which section is slightly convexly curved. Therefore, the panel of this embodiment is not flat and it contributes in part to the convex curvature, and a load spreading structure, of the sides of the lid.

The panel is a single piece of pressed aluminium plate which is not of the composite structure of its earlier counterpart. Insulation is provided, not as an insulating layer 61 sandwiched withing the composite structure of the panel 48, but as an insulating liner 84 and quilted layer 86.

the upper edge 62 of the sidewall carries an inwardly recessed profile 86. In 10 engaging the panel 48B to the sidewall 50, the edge 82 of the panel 48B fits above the profile 86 and is secured thereto by passing a plurality of screws (or rivets) 88 through respective holes in the profile and into respective recesses (not shown) on an inner side of the outer section 80.

1. A rooftop tent enclosure which includes a base detachably fixed to a roof of a the vehicle, which includes a first load bearing flat base panel and a perimeter frame which engages a perimeter of the first base panel, a base extension rotatably connected to the base, a cover rotatably connected to the base to open and close on an upper surface of the base, which includes a second load bearing panel and a sidewall which extends between an upper edge and a lower edge and which engages the second panel along the upper edge.

2. A rooftop tent enclosure according to claim 1 wherein the base extension includes a third load bearing panel and a perimeter mount which engages a perimeter of the third panel.

3. A rooftop tent enclosure according to claim 2 wherein each of the first, second and third panels include an upper rigid plate and a lower rigid plate and a core sandwiched between the upper and the lower plates.

4. A rooftop tent enclosure according to claim 2 wherein each of the first and third panels include an upper rigid plate and a lower rigid plate and a core sandwiched between the upper and the lower plates and the second panel is composed of a single rigid plate.

5. A rooftop tent enclosure according to claim 3 or 4 wherein the rigid plates are made of aluminum aluminium, fiberglass fibreglass or carbon fiber fibre.

6. A rooftop tent according to claim 5 wherein single rigid plate is a pressed aluminum aluminium plate.

7. A rooftop tent according to claim 3 wherein the core is a structural foam, made of any one of the following: an expanded polypropylene foam, a polyurethane foam and a polyvinylchloride foam.

8. A rooftop tent according to claim 3 wherein the core has a honeycomb configuration, made of rigid plastics material.

9. A rooftop tent according to claim 1 wherein the sidewall has a modular configuration, comprising four side-panels and four corner panels, each corner panel connecting a respective pair of side panels.

10. A rooftop tent according to claim 9 wherein the side-panels and the corner panels are convexly curved from a lower edge of a first perimetrical extent, to an upper edge of a second perimetrical extent, wherein the first perimetrical extent is larger than the second perimetrical extent.

11. A rooftop tent according to claim 1 wherein the perimeter frame has a modular configuration, comprising four side channels, each corner element connecting a respective pair of side channels.

12. A rooftop tent according to claim 1 wherein the perimeter mount has a modular configuration, comprising four side rails and at least two corner pieces, each corner piece connecting a respective pair of side rails.

13. A rooftop tent for a vehicle which includes a base detachably fixed to a roof of a vehicle, which includes a first load bearing panel and a perimeter frame which engages a perimeter of the first panel, a base extension rotatably connected to the base, a cover rotatably connected to the base to open and close on an upper surface of the base, which includes a second load bearing panel and a sidewall which extends between an upper edge and a lower edge, which engages the second flat at the upper edge, a tent unit connected to the base plate and the cover.

14. A rooftop tent for a vehicle according to claim 13 wherein the base extension moves from a first position in which the base extension overlaps the base, to a second position in which the base extension extends from the base to form a single flat-bed deck.

15. A rooftop tent according to claim 13 wherein the tent unit moves from a folded configuration when the cover is closed and the base extension is in the first position, to an open configuration when the cover is open and the base extension is in the second position.
